(19) United States
(12) Patent Application Publication
(10) Pub. No.: US 2020/0234266 A1
(43) Pub. Date: Jul. 23, 2020

(54) SALES DATA PROCESSING APPARATUS AND PROGRAM

(71) Applicant: TOSHIBA TEC KABUSHIKI KAISHA, Tokyo (JP)

(72) Inventor: Masahiko SUGIMOTO, Mishima Shizuoka (JP)

(21) Appl. No.: 16/691,076

(22) Filed: Nov. 21, 2019

(30) Foreign Application Priority Data
Jan. 23, 2019 (JP) 2019-009168

(51) Int. Cl. G06Q 20/20

(52) U.S. Cl. CPC G06Q 20/208; G06Q 20/209

(57) ABSTRACT

A sales data processing apparatus includes a housing section configured to house a container for at least one commodity, a settlement section configured to perform settlement processing based on tag information related to the at least one commodity read from a wireless tag attached to the at least one commodity in the container in the housing section, and a marking section configured to mark, upon completion of the settlement processing, the container to indicate completion of the settlement processing.

### CROSS-REFERENCE TO RELATED APPLICATION

This application is based upon and claims the benefit of priority from Japanese Patent Application No. 2019-009168, filed in Jan. 23, 2019, the entire contents of which are incorporated herein by reference.

### FIELD

Embodiments described herein relate generally to a sales data processing apparatus and a program.

### BACKGROUND

When a customer shops at a store such as a supermarket or a convenience store, the customer receives a basket or cart in which the commodities the customer wants to purchase are put. The customer moves around in the store and puts commodities to be purchased in the basket or cart. When the customer is finished selecting the commodities to be purchased, the customer takes the basket or cart including the commodities to a settlement section. A store clerk or the customer executes settlement processing for the commodities in a sales data processing apparatus such as a POS terminal disposed in the settlement section. That is, the store clerk or the customer causes the sales data processing apparatus to read wireless tags attached to the commodities. The customer executes payment for the purchased commodities. The commodities for which the settlement processing is finished are automatically or manually transferred to a register bag.

Therefore, in order to distinguish the commodities before the settlement and the commodities after the settlement, the store needs to provide the basket or the cart to put the commodities in before settlement and the register bag to put the commodities in after settlement and indicate that the settlement processing is finished.

### DESCRIPTION OF THE DRAWINGS

FIG. 1 is a perspective view illustrating a self-service POS terminal according to a first embodiment;

FIG. 2 is an explanatory diagram illustrating the internal structure of a housing section from the front side;

FIG. 3 is a block diagram illustrating a hardware configuration of the self-service POS terminal;

FIG. 4 is a functional block diagram illustrating a functional configuration of the self-service POS terminal;

FIG. 5 is a diagram illustrating an example of printing on a register bag;

FIG. 6 is a flowchart illustrating a flow of control processing of the self-service POS terminal;

FIG. 7 is a diagram illustrating another example of the printing on the register bag;

FIG. 8 is a diagram illustrating still another example of the printing on the register bag;

FIG. 9 is a block diagram illustrating a hardware configuration of a self-service POS terminal according to a second embodiment;

FIG. 10 is a functional block diagram illustrating a functional configuration of the self-service POS terminal according to the second embodiment; and

FIG. 11 is a flowchart illustrating a flow of control processing of the self-service POS terminal according to the second embodiment.

### DETAILED DESCRIPTION

Embodiments provide a sales data processing apparatus and a program for enabling a store to distinguish commodities before settlement and the commodities after the settlement without providing a basket or cart in which the commodities are put before the settlement.

A sales data processing apparatus according to an embodiment includes: a housing section configured to house a container for at least one commodity; a settlement section configured to perform settlement processing based on tag information related to the at least one commodity read from a wireless tag attached to the at least one commodity in the container; and a marking section configured to mark, upon completion of the settlement processing, the container to indicate completion of the settlement processing.

### First Embodiment

A sales data processing apparatus and a program according to a first embodiment are explained with reference to the drawings. In the first embodiment, a self-service POS terminal is an example of a sales data processing apparatus. In the first embodiment, a register bag is an example of a container. In the first embodiment, a timer is an example of a clock section. The present invention is not limited by embodiments explained below.

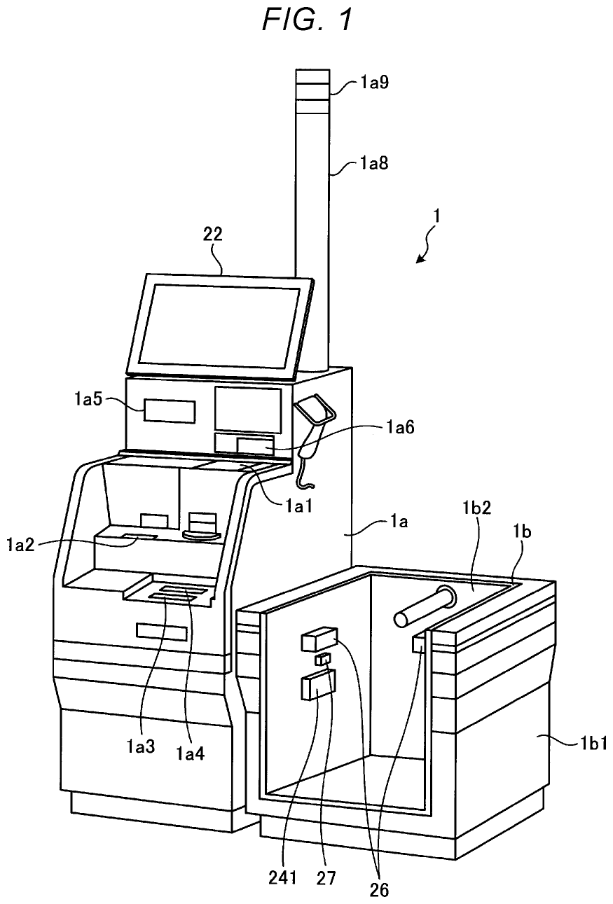

First, the self-service POS terminal is explained. FIG. 1 is a perspective view illustrating the self-service POS terminal according to the first embodiment. As illustrated in FIG. 1, a self-service POS terminal 1 includes a main body section 1a and a housing section 1b provided separately from the main body section 1a.

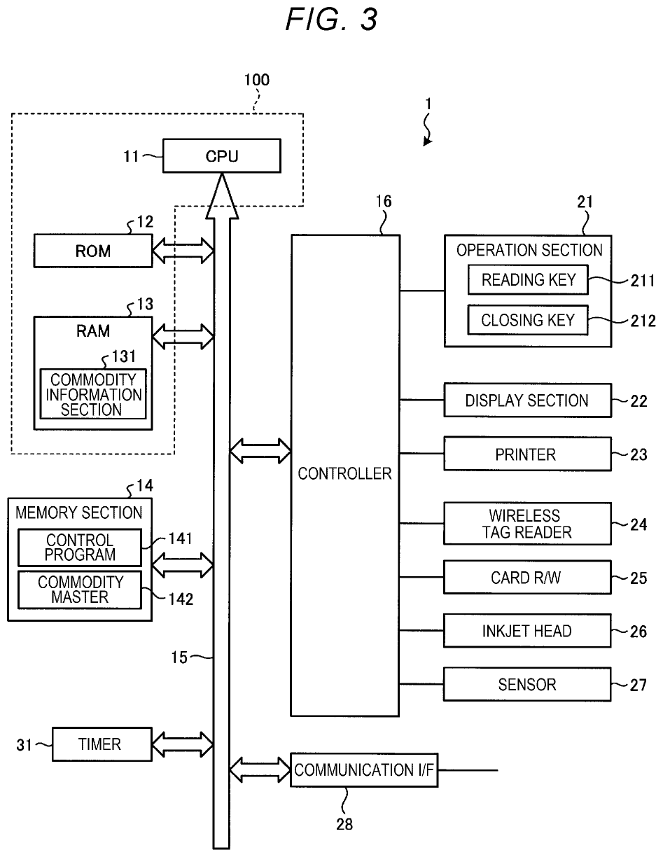

The self-service POS terminal 1 is an apparatus that a customer operates to perform sales registration processing and settlement processing for commodities that the customer purchases. The sales registration processing refers to processing for reading tag information from a wireless tag attached to a commodity for sale to acquire a commodity code (more generally, commodity specifying information) for specifying the commodity, reading out commodity information (e.g., a commodity name, a price, and the like) of the commodity from a commodity master based on the acquired commodity code, displaying the commodity information, and storing the commodity information in a commodity information section 131 (see FIG. 3). The settlement processing refers to, for example, processing for, based on the commodity information stored in the commodity information section 131, displaying a total amount and a tax amount related to a transaction and calculating change based on a payment received from the customer and displaying the change, processing for instructing a change machine to issue change, and processing for issuing a receipt on which the commodity information and settlement information (the total amount, a deposit amount, a change amount, and the like) are printed. The commodity information and the settlement information are collectively referred to as sales information.

The main body section 1a of the self-service POS terminal 1 houses, on the inside, a control section 100 (i.e., a controller) (see FIG. 3) explained below and a coin change machine, a bill change machine, a power supply section (all of which are not illustrated). The main body section 1a includes a coin depositing section 1a1 in which coins received from the customer are deposited, a coin dispensing port 1a2 from which change in coins is dispensed, a bill depositing section 1a3 in which bills received from the customer are deposited, a bill dispensing port 1a4 from which change in bills is dispensed, a receipt issuing port lay from which a receipt on which commodity information and settlement information are printed is issued, and a card insertion port 1a6 into which a card is inserted for settlement by the card.

Coins deposited in the coin depositing section 1a1 are stored in the coin change machine. Coins stored in the coin change machine are dispensed as change to the coin dispensing port 1a2. Bills deposited in the bill depositing section 1a3 are stored in the bill change machine. Bills stored in the bill change machine are dispensed as change to the bill dispensing port 1a4.

The main body section 1a includes a display section in an upper part. The display section 22 displays commodity information and settlement information to the customer. The main body section 1a includes a columnar pole 1a8 and includes a patrol lamp 1a9 at the upper distal end portion. The patrol lamp 1a9 is a lamp that shines in order to inform an attendant that, for example, an error occurs in the self-service POS terminal 1 or the customer does not understand operation of the self-service POS terminal 1.

The housing section 1b houses a register bag in which commodities are put to be purchased by the customer. The housing section 1b collectively reads tag information of the commodities that are put in the register bag that is placed in the housing section 1b. The housing section 1b includes a box-like main body section 1b1 and a lid section 1b2 in an upper part. The lid section 1b2 opens and closes the inside of the housing section 1b.

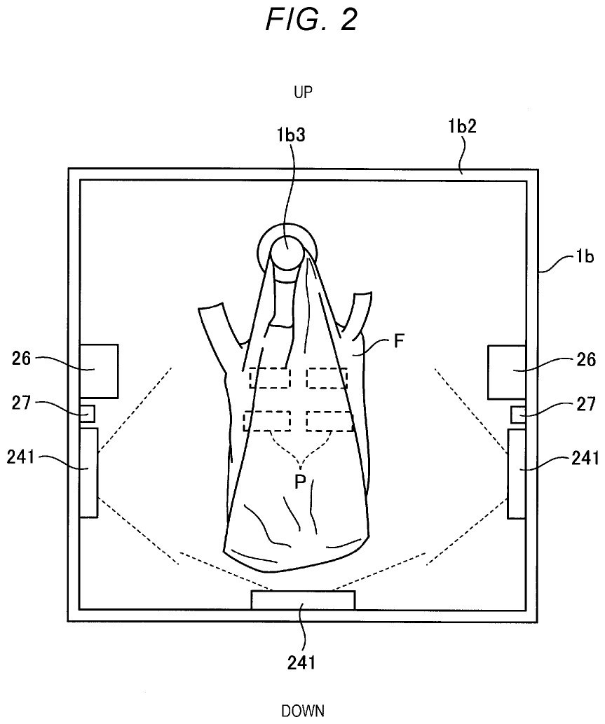

FIG. 2 is an explanatory diagram illustrating the internal structure of the housing section 1b from the front side. The housing section 1b has structure open in the front and the top. The housing section 1b includes, in an upper part on the inside, a bar-like supporting section 1b3 on which a grip of a register bag F is hung. The customer hangs, on the supporting section 1b3, the register bag F including commodities P.

The housing section 1b includes antennas 241 in side portions and a bottom portion on the inside. The antennas 241 are electrically connected to a wireless tag reader 24 (see FIG. 3) and transmit radio waves toward the commodities P. Wireless tags, which receive the radio waves, transmit tag information including commodity specifying information for specifying the commodities P. The antennas 241 receive the tag information transmitted from the wireless tags. In this way, the wireless tag reader 24 reads the tag information related to all the commodities P put in the register bag F.

The housing section 1b includes, in side portions on the inside, sensors 27 that detect whether the register bag F is hung on the supporting section 1b3. The sensors 27 are, for example, sensors of a transmission type. One sensor 27 is configured as a light emitting section. The other sensor 27 is configured as a light receiving section. If light radiated from the light emitting section is not received by the light receiving section, the sensors 27 output an indication that the register bag F is hung on the supporting section 1b3. If the light radiated from the light emitting section is received by the light receiving section, the sensors 27 output an indication that the register bag F is not hung on the supporting section 1b3.

The housing section 1b includes, on the inside, inkjet heads 26 that eject ink. The inkjet heads 26 eject the ink to the register bag F hung on the supporting section 1b3 and print a character or a figure on the register bag F. The inkjet heads 26 eject color ink. The inkjet heads 26 are provided on two opposed surfaces. However, an inkjet head 26 may also be provided on the rear surface of the housing section 1b in addition to the two opposed surfaces. In the embodiment, as illustrated in FIG. 1, the inkjet heads 26 are provided on three surfaces, that is, the two opposed surfaces and the rear surface.

Hardware of the self-service POS terminal 1 is explained. FIG. 3 is a block diagram illustrating a hardware configuration of the self-service POS terminal. As illustrated in FIG. 3, the self-service POS terminal 1 includes a CPU (Central Processing Unit) 11, a ROM (Read Only Memory) 12, a RAM (Random Access Memory) 13, and a memory section 14. The CPU 11 is a control entity. The ROM 12 stores various computer programs. The computer programs and various data are developed on the RAM 13. The memory section 14 stores various computer programs. The CPU 11, the ROM 12, the RAM 13, and the memory section 14 are connected to one another via a bus 15. The CPU 11, the ROM 12, and the RAM 13 configure the control section 100. That is, the CPU 11 operates according to a control program stored in the ROM 12 or the memory section 14 and developed on the RAM 13, whereby the control section 100 executes control processing of the self-service POS terminal 1.

The RAM 13 includes the commodity information section 131. The commodity information section 131 stores commodity information (a commodity name, a price, and the like) of a commodity acquired from a commodity master 142.

The memory section 14 is configured by a HDD (Hard Disc Drive), a flash memory, or the like and maintains storage content even if a power supply is shut down. The memory section 14 includes a control program section 141 and the commodity master 142. The control program section 141 stores a control program for controlling the self-service POS terminal 1. The commodity master 142 stores commodity information of a commodity in association with a commodity code (i.e., commodity specifying information) for specifying the commodity.

An operation section 21, the display section 22, a printer 23, a wireless tag reader 24, a card reader/writer (R/W) 25, the inkjet heads 26, the sensors 27, and the like are connected to the control section 100 via the bus 15 and a controller 16.

The operation section 21 is a keyboard including a reading key 211 and a closing key 212. The reading key 211 is a key for starting the reading of the wireless tags attached to the commodities put in the register bag F hung on the supporting section 1b3. The closing key 212 is a key for starting settlement processing of the commodities subjected to the sales registration processing and is operated if the transaction with the customer is ended.

The display section 22 displays information to the customer who operates the display section 22. The printer 23 issues a receipt formed by printing sales information on a sheet. The wireless tag reader 24 transmits radio waves to the inside of the housing section 1b from the antennas 241 and receives, with the antennas 241, the tag information of the wireless tags attached to the commodities in the housing section 1b and reads the tag information. The card R/W 25 reads card specifying information from a card (e.g., a credit card) used for payment by the customer.

The control section 100 is connected to a communication interface (I/F) 28 and a clock section (timer) 31 via the bus 15. The control section 100 is capable of mutually communicating with a host server (not illustrated) and other self-service POS terminals 1 via the communication interface 28. The timer 31 keeps and outputs present date and time.

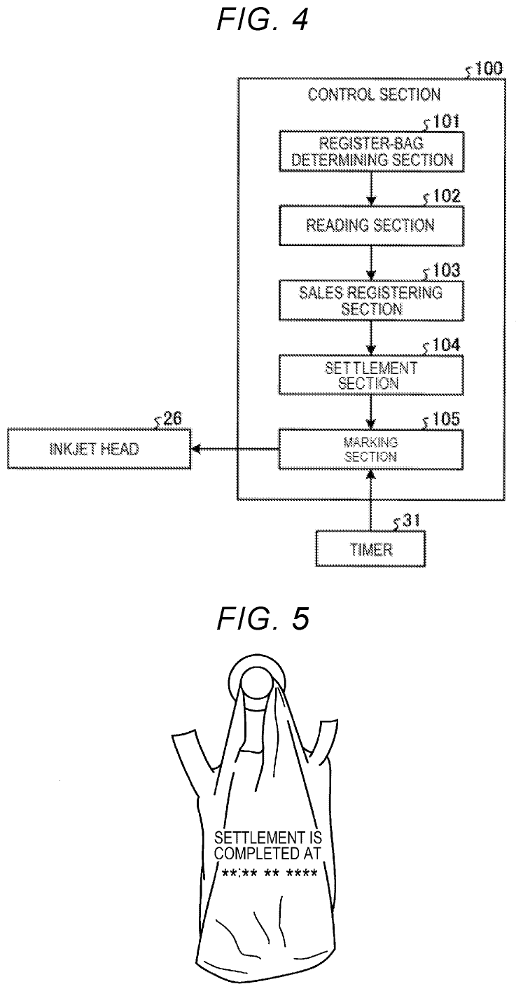

A functional configuration of the self-service POS terminal 1 according to the first embodiment is explained. FIG. 4 is a functional block diagram illustrating a functional configuration of the self-service POS terminal 1. As illustrated in FIG. 4, the control section 100 of the self-service POS terminal 1 conforms to the control program stored in the control program section 141 and developed on the RAM 13 to function as a register-bag determining section 101, a reading section 102, a sales registering section 103, a settlement section 104, and a marking section 105.

The register-bag determining section 101 determines, based on outputs from the sensors 27, whether the register bag F is detected. Specifically, if the reading key 211 is operated, the register-bag determining section 101 determines, based on the outputs from the sensors 27, whether the register bag F is detected.

If the register-bag determining section 101 detects the register bag F, the reading section 102 transmits radio waves from the antennas 241 and reads tag information including commodity specifying information from the wireless tags attached to the commodities put in the register bag F.

The sales registering section 103 reads out commodity information from the commodity master 142 based on the commodity specifying information read by the reading section 102 and executes sales registration processing for the commodities put in the register bag F.

The settlement section 104 performs settlement processing based on the tag information of the commodities read from the wireless tags attached to the commodities put in the register bag F in the housing section 1b. The settlement section 104 executes the settlement processing for the commodities based on the commodity information of the commodities for which the sales registering section 103 performs the sale registration processing. Specifically, for example, if settlement is performed by cash, the settlement section 104 dispenses, based on an amount of money (bills and coins) deposited by the customer and a total price of the commodities, change if change is required and issues, from the printer 23, a receipt on which the commodity information and settlement information (the total amount, a deposit amount, a change amount, and the like) of the commodities of the sale registration processing are printed.

The marking section 105 marks, on condition that the settlement section 104 performs the settlement processing, the register bag F in the housing section 1b to indicate the completion of the settlement processing. On completion of the settlement processing, the marking section 105 ejects the ink from the inkjet heads 26 and prints information such as a character, an image, or a mark on the register bag F to mark the register bag F to make it possible to visually recognize that the settlement is completed. For example, as illustrated in FIG. 5, the marking section 105 prints on the register bag F a date or a date and time of the settlement processing based on date and time information clocked by the timer 31.

By changing day and/or time information printed on the register bag F in this way, it is possible to prevent the customer from re-using the register bag F at a later day and/or time to illegally obtain commodities from the store.

The marking section 105 may mark the register bag F differently according to the size of the register bag F. In general, the register bag F has a size corresponding to the quantity of purchased commodities, For example, a large register bag F is used for a customer who purchases a large number of commodities. For example, a large mark is printed on the large register bag F. Therefore, it is possible to estimate the quantity of purchased commodities from a mark printed according to the size of the register bag F. For example, if only a few commodities are put in the register bag F on which the large mark is printed, it is possible that the register bag is being illegally re-used.

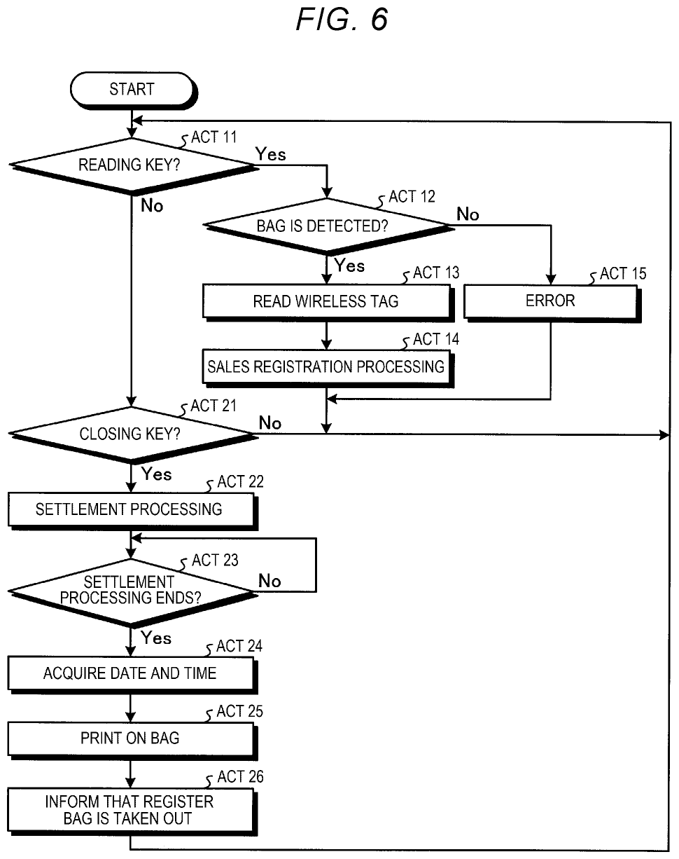

Control of the self-service POS terminal 1 according to the first embodiment is explained. FIG. 6 is a flowchart illustrating a flow of control processing of the self-service POS terminal 1. As illustrated in FIG. 6, the control section 100 of the self-service POS terminal 1 determines whether the reading key 211 is operated (Act 11). If operation of the reading key 211 is determined (Yes in Act 11), the register-bag determining section 101 determines, based on outputs from the sensors 27, whether the register bag F is detected (Act 12). If the register-bag F is detected (Yes in Act 12), the reading section 102 transmits radio waves from the antennas 241 and reads tag information including commodity specifying information from radio tags attached to commodities put in the register bag F (Act 13). The sales registering section 103 reads out commodity information from the commodity master 142 based on the commodity specifying information and executes sales registration processing for the commodities put in the register bag F (Act 14). The control section 100 returns to Act 11. If the register-bag F is not detected (NO in Act 12), the control section 100 executes error processing (Act 15). The control section 100 returns to Act 11.

If it is determined in Act 11 that the reading key 211 is not operated (No in Act 11), the control section 100 determines whether the closing key 212 is operated (Act 21). If the control section 100 determines that the closing key 212 is operated (Yes in Act 21), the settlement section 104 reads out, from the commodity information section 131, the commodity information of the commodities, for which the sales registering section 103 performs the sales registration processing in Act 14, and executes settlement processing for the commodities (Act 22).

Subsequently, the control section 100 determines whether the settlement processing by the settlement section 104 ends (Act 23). If a predetermined time elapses after the settlement section 104 starts the settlement processing in Act 22, the control section 100 determines that the settlement processing by the settlement section 104 ends. The control section 100 stays on standby until the settlement processing by the settlement section 104 ends (No in Act 23). If the settlement processing ends (Yes in Act 23), the control section 100 acquires present day and time information clocked by the timer 31 (Act 24).

Subsequently, the marking section 105 marks the register bag F in the housing section 1b to indicate the completion of the settlement processing (Act 25). That is, the marking section 105 ejects the ink from the inkjet heads 26 and prints, on the register bag F, based on the date and time information acquired from the timer 31, a date or a date and time of an end of the settlement processing to make it possible to visually recognize that the settlement processing is completed (Act 25). When the marking indicates the completion of the settlement processing, the control section 100 displays, on the display section 22, a message indicating that the register bag F may be taken out (Act 26). The control section 100 returns to Act 11. If it is determined that the closing key 212 is not operated (No in Act 21), the control section 100 returns to Act 11.

According to the first embodiment, the register bag F subjected to the settlement processing is marked to indicate the completion of the settlement processing using the inkjet heads 26. Therefore, the store is capable of distinguishing commodities before settlement and the commodities after the settlement without providing a basket or cart in which the commodities are put before the settlement.

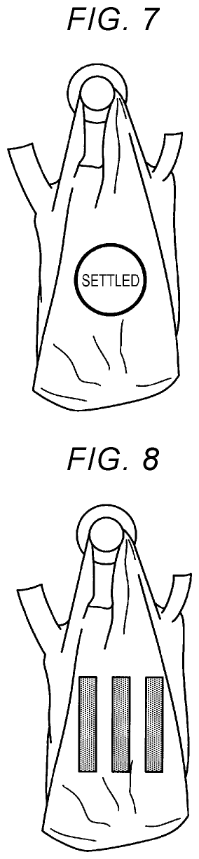

As illustrated in FIG. 7, the marking section 105 may print, on the register bag F, a character indicating that the settlement processing is finished. The marking section 105 may change, for example, every day, a color, a shape, size, and the like of information printed on the register bag F. For example, as illustrated in FIG. 8, the marking section 105 changes, in a time unit, the shape of the information printed on the register bag F. For example, as illustrated in FIG. 8, a figure having a shape capable of distinguishing a day of the week when commodities are purchased is printed.

The marking section 105 changes, based on the date and time clocked by the timer 31, in a day or a date and time marking, for example, any one of the color, the size, and the shape of the information printed on the register bag F. For example, the marking unit 105 changes, in a day marking, the shape of the information printed on the register bag F. For example, the marking unit 105 changes, in a day marking, the size of the information printed on the register bag F.

### Second Embodiment

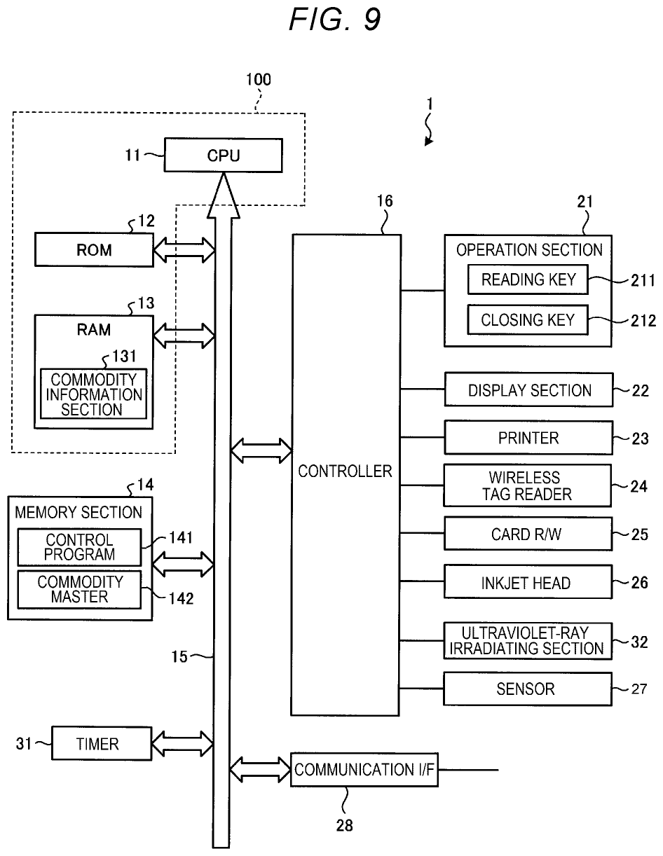

A second embodiment is explained. FIG. 9 is a block diagram illustrating a hardware configuration of the self-service POS terminal 1 according to the second embodiment. In FIG. 9, the same components as the components illustrated in FIG. 3 are denoted by the same reference numerals and signs. Explanation of those components is not repeated. The self-service POS terminal 1 according to the second embodiment includes ultraviolet-ray irradiating sections 32 instead of the inkjet heads 26. The ultraviolet-ray irradiating sections 32 are attached to substantially the same positions as the attachment positions of the inkjet heads 26 in FIG. 2. The ultraviolet-ray irradiating sections 32 can irradiate ultraviolet rays over substantially the entire register bag F hung on the supporting section 1b3.

Paint is applied to the register bag F used in the second embodiment. A color of the paint changes when an ultraviolet ray is irradiated on the paint. The paint may be applied to the entire register bag F or may be applied to, for example, a most conspicuous portion of the register bag F (e.g., near the center of the register bag F).

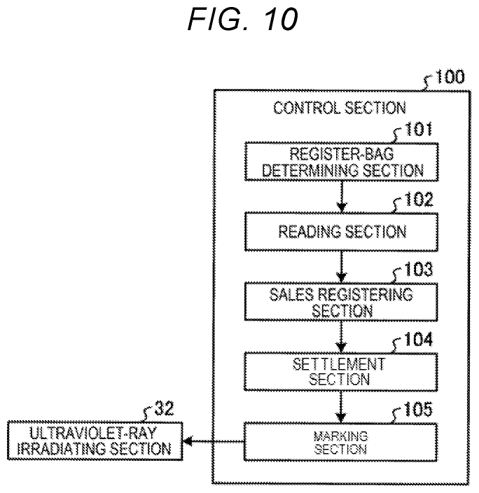

FIG. 10 is a functional block diagram illustrating a functional configuration of the self-service POS terminal according to the second embodiment. In FIG. 10, the same components as the components illustrated in FIG. 4 are denoted by the same reference numerals and signs. Explanation of the components is omitted. As illustrated in FIG. 10, the marking section 105 marks, on condition that the settlement section 104 performs the settlement processing, the register bag F in the housing section 1b to indicate the completion of the settlement processing. That is, on condition that the settlement section 104 performs the settlement processing, the marking section 105 irradiates ultraviolet rays on the register bag F from the ultraviolet-ray irradiating sections 32 to change a color of the entire register bag F or change a color of a part of the register bag F and prints information such as a character, an image, or a mark on the register bag F to make it possible to visually recognize that the settlement is completed.

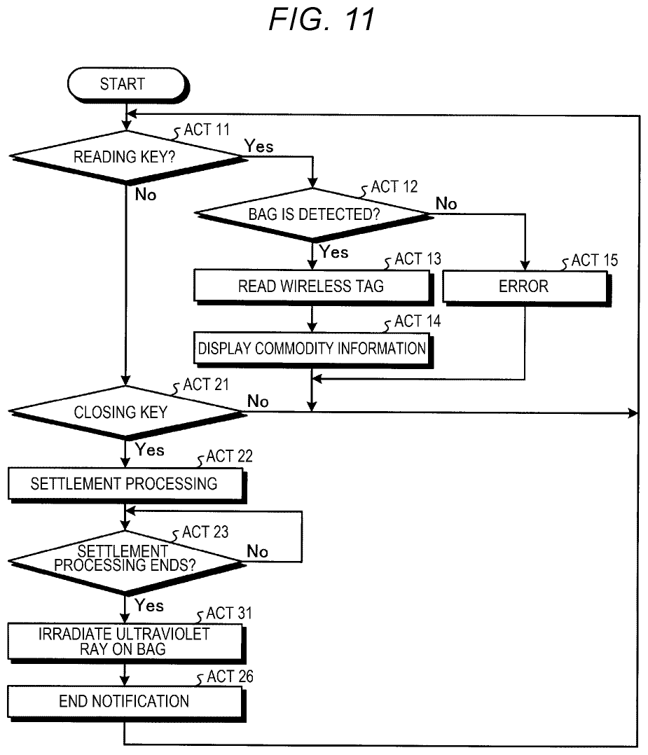

Control of the self-service POS terminal 1 according to the second embodiment is explained. FIG. 11 is a flowchart illustrating a flow of control processing of the self-service POS terminal according to the second embodiment. In FIG. 11, the same controls as the controls in FIG. 6 are denoted by the same reference sings. Explanation of those controls is not repeated. As illustrated in FIG. 11, if it is determined that the settlement processing ends (Yes in Act 23), the marking section 105 irradiates ultraviolet rays on the register bag F from the ultraviolet-ray irradiating sections 32 to mark the register bag F to indicate the completion of the settlement processing (Act 31). That is, the marking section 105 irradiates the ultraviolet rays on the register bag F from the ultraviolet-ray irradiating sections 32 to change the color of the register bag F to make it possible to visually recognize that the settlement processing of the register bag F is completed (Act 31). The control section 100 executes and end notification processing in Act 26.

According to the second embodiment, the ultraviolet rays are irradiated from the ultraviolet-ray irradiating sections 32 to mark the register bag F to indicate the completion of the settlement processing. Therefore, the store is capable of distinguishing commodities before settlement and the commodities after the settlement without providing a basket or cart in which the commodities are put before the settlement.

The embodiments of the present invention are explained above. However, the embodiments are presented as examples and are not intended to limit the scope of the invention. The embodiments can be implemented in other various forms. Various omissions, substitutions, and changes can be made without departing from the spirit of the invention. The embodiments and modifications of the embodiments are included in the scope and the gist of the invention and included in the inventions described in claims and the scope of equivalents of the inventions.

For example, in the embodiments, the register bag F is explained as an example of the container. However, the container is not limited to the register bag F and may be, other than the register bag F, a bag, a basket, or the like that stores commodities.

In the embodiments, the main body section 1a and the housing section 1b are explained as separate bodies. However, the main body section 1a and the housing section 1b may be respectively devices housed in the same housing.

In the embodiments, if the reading key 211 is operated in Act 11, it is determined in Act 12 whether the register bag F is detected. However, the processing is not limited to this. The determination in Act 12 may always be performed even if the reading key 211 is not operated. In this case, irrespective of operation or nonoperation of the reading key 211, the register-bag determining section 101 always determines that the register bag F is not detected if the register bag F is not hung on the supporting section 1b3 and always determines that the register bag F is detected if the register bag F is hung on the supporting section 1b3.

The computer programs executed in the self-service POS terminal 1 in the embodiments are provided while being recorded in a computer-readable recording medium such as a CD-ROM, a flexible disk (FD), a CD-R, or a DVD (Digital Versatile Disk) as a file of an installable form or an executable form.

The computer programs executed in the self-service POS terminal 1 in the embodiments may be stored on a computer connected to a network such as the Internet and provided by being downloaded through the network. The computer programs executed in the self-service POS terminal 1 in the embodiments may be provided or distributed through a network such as the Internet.

The computer programs executed in the self-service POS terminal 1 in the embodiments may be incorporated in a ROM or the like in advance to the self-service POS terminal.

What is claimed is:

1. A sales data processing apparatus comprising:
a housing section configured to house a container for at least one commodity;
a settlement section configured to perform settlement processing based on tag information related to the commodity read from a wireless tag attached to the at least one commodity in the container in the housing section; and
a marking section configured to mark, upon completion of the settlement processing, the container to indicate completion of the settlement processing.

2. The apparatus according to claim 1, wherein
the housing section includes an inkjet head, and
the marking section controls the inkjet head to deposit, on the container, ink ejected from the inkjet head to mark the container to indicate the completion of the settlement processing.

3. The apparatus according to claim 2, further comprising a timer configured to track a date and time, wherein
the marking section prints, using the inkjet head, a date or a date and time of settlement on the container to indicate the completion of the settlement processing.

4. The apparatus according to claim 2, wherein the marking section prints a mark indicating the completion of the settlement processing on the container using the inkjet head.

5. The apparatus according to claim 4, wherein one of a color, a shape, or a size of the mark denotes a day of the completion of the settlement processing.

6. The apparatus according to claim 4, wherein the marking section changes a size or a shape of the mark depending on a time of day of the completion of the settlement processing.

7. The apparatus according to claim 4, wherein a size of the mark corresponds to a size of the container.

8. The apparatus according to claim 4, wherein a size of the mark corresponds to a quantity of the at least one commodity in the container.

9. The apparatus according to claim 1, wherein
the housing section includes an ultraviolet-ray irradiating section configured to irradiate an ultraviolet ray toward the container in the housing section, and
the marking section controls the ultraviolet-ray irradiating section to irradiate the ultraviolet ray on the container which is applied with paint which changes color when the ultraviolet ray is irradiated thereon.

10. The apparatus according to claim 9, wherein the marking section controls the ultraviolet-ray irradiating section to print information on the container.

11. A sales data processing method for a sales data processing apparatus including a housing section configured to house a container including a commodity contained therein,
the sales data processing method comprising:
performing settlement processing based on tag information related to the commodity read from a wireless tag attached to the commodity put in the container housed in the housing section; and
marking, on condition that the settlement processing is performed, the container to indicate completion of the settlement processing.

12. The method according to claim 11, wherein
marking comprises controlling an inkjet head to deposit, on the container, ink ejected from the inkjet head to mark the container to indicate the completion of the settlement processing.

13. The method according to claim 12, further comprising:
tracking a date and time, and
the marking comprises printing a date or a date and time of settlement on the container to indicate the completion of the settlement processing.

14. The method according to claim 12, wherein the marking comprises printing a mark indicating the completion of the settlement processing on the container using the inkjet head.

15. The method according to claim 14, wherein one of a color, a shape, or a size of the mark denotes a day of the completion of the settlement processing.

16. The method according to claim 14, further comprising changing a size or a shape of the mark depending on a time of day of the completion of the settlement processing.

17. The method according to claim 14, wherein a size of the mark corresponds to a size of the container.

18. The method according to claim 14, wherein a size of the mark corresponds to a quantity of the at least one commodity in the container.

19. The method according to claim 11, wherein
the housing section includes an ultraviolet-ray irradiating section configured to irradiate an ultraviolet ray toward the container in the housing section, and
the marking comprises controlling the ultraviolet-ray irradiating section to irradiate the ultraviolet ray on the container which is applied with paint which changes color when the ultraviolet ray is irradiated thereon.

20. The method according to claim 19, wherein the ultraviolet-ray irradiating section is controlled to print information on the container.
